(19) United States
(12) Patent Application Publication
(10) Pub. No.: US 2005/0235155 A1
(43) Pub. Date: Oct. 20, 2005

(54) Identification of users on a network

(75) Inventors: Lucas Lopatin, Buenos Aires (AR); Manuel Caballero, Buenos Aires (AR); Samuel S. Tenembaum, Punta Del Este (UY); Diego Dayan, Buenos Aires (AR); Abel Gordon, Haifa (IL); Moises Swiczar, Buenos Aires (AR)

Correspondence Address: DARBY & DARBY P.C., P. O. BOX 5257, NEW YORK, NY, 10150-5257, US

(73) Assignees: Porto Ranelli, SA, Punta Del Este (UY); PI Trust, New York, NY (US)

(21) Appl. No.: 10/493,737

(22) PCT Filed: Jul. 30, 2002
(86) PCT No.: PCT/US02/24224

§ 371 Date: Oct. 26, 2004

Related U.S. Application Data
(60) Provisional application No. 60/309,799, filed on Aug. 3, 2001.
(60) Provisional application No. 60/309,933, filed on Aug. 3, 2001.
(60) Provisional application No. 60/347,834, filed on Oct. 24, 2001.

(51) Int. Cl. G06F 15/173; G06F 12/14; H04L 9/00

(52) U.S. Cl. 713/182

(57) ABSTRACT

The present invention enables the reading and writing of files stored in the cache of a web browser (100) without the use of cookies. The user requests an uncokie (hookie) from browser (100). The browser checks to see if the uncookie is cached within itself (102). If not, the browser requests (110) the uncookie from the server.

### FIELD OF THE INVENTION

The present invention relates generally to methods and apparatus for identifying and storing information regarding individual users on a network without using cookies.

### BACKGROUND OF THE INVENTION

Just as computer networks have gained widespread use in business, the Internet (one example of a computer network) has gained widespread use in virtually every aspect of our lives, owing primarily to the popularity of the worldwide web. The Internet includes servers (computers), which offer electrical communication to client computers (operated by users) and other servers. The computers involved may range from mainframes to cellular telephones, and they may operate over any conceivable communication medium.

Most users connect to the Internet (or “surf the net”) through a personal computer running an operating system with a graphic user interface (GUI), such as one of the Windows® operating systems. A user communicates over the Internet using a program called a “browser” running on his computer, the two most popular ones being Internet Explorer and Netscape, although many other browsers are in common use. The browser receives files in a format known as HTML, which is a mark-up language that permits multimedia to be embedded within formatted and stylized text, and it displays “pages”, which may play sound and exhibit graphics and video. Various programming languages, such as Javascript, are also available which permit executable code to be embedded in an HTML file and to run and to perform useful tasks when a browser presents the file to the user. Those skilled in the art will appreciate that browsers are not limited to use on the Internet, but are now widely used for general communication on networks, including Intranets.

Cookies are small files stored inside a web user's computer that are used to save client-specific information. They have been used for the identification of a computer when negotiating a connection to a server, and they thereby make possible the customization of content or advertisements transferred to the client computer.

Several tools and commands are built into browsers to manage, read, write and use cookies to store information. Also, administrative tools are provided to users in order to control access to cookies, even preventing their use completely which limits the server's ability to identify users and therefore tailor content and commercial message delivered.

Certain websites, and even the legislatures in a few countries (e.g. Germany), limit the use of cookies because of privacy concerns. Also, some users disable them or constrain their use through custom settings in the preferences of their browsers. And lately, new versions of browsers add tools to empower users so that they can control access to their cookies. All this limits the server's ability to identify users and therefore tailor content and delivery of commercials

In order to circumvent these limitations, the present invention avoids the use of the client computer files entirely or delivers cookie functionality by making use of a file which is cached in the Internet cache of the user's computer, yet is not recognized by the user's browser as a cookie. This file is stored in the temporary directory used for all cached Internet files. It can contain the history of a user and include any information that may be utilized to customize content or advertisement.

In accordance with one aspect associated with a first embodiment, the present invention enables the reading and writing of files stored in the cache of a web browser in a completely novel way that until now was only possible using cookies. By utilizing this technique, web programmers, content and advertisement servers can overcome the limitations built into cookie technology. This aspect of the invention, hereafter referred to as Hookies or Uncookies, allows for the same type of file management found in cookies, without resorting to cookie programming. This results in increased functionality, since many cookie limitations are avoided, like their file size restrictions and user defined accessibility.

In accordance with another aspect of the invention related to other embodiments, an identification code is made available in a users computer, either as a file stored in the browser cache in the manner described above or in hardware in the user's computer. This identification code is then matched with records stored in a database.

The various embodiments of the invention can be used, among other things, to:
Identify unique Internet users without using cookies.
Identify unique Internet users from a variety of web servers.
Maintain updated information about a user without using cookies.
Share information about a user across different sites.
   Override user defined limitations in storing and accessing information in the user's computer.
   Preserve information on the user's side despite cookies being deleted or blocked.

In its preferred form, an Hookie is a JavaScript file with a URL (the type of identifier used for websites) for a name. Tools exist for programmers to manage cookies, which allow for the storage and access of information on the user's side. If a file is not defined as a cookie, there are no special commands provided to manage it. The current invention creates this capability Hookies.

The placement of a Hookie, in the computer's Internet cache entails a series of considerations:

1. It is inherently less durable, since caches are erased periodically according to preferences.

2. Its access cannot be limited by the user through the modification of preferences. Neither can it be blocked by cookie managing software or websites that do not allow them.

3. Hookies can contain unlimited amounts of data, unlike cookies.

4. Unlike cookies, which can only be accessed by authorized servers, information stored in Hookies can be accessed by any Uncookie aware server.

The fourth point leads to an ancillary use of Hookies: sharing user information across different servers. This enables the creation of a “site consortium” made up of assorted sites sharing user information among themselves, therefore sharing knowledge which could be used to enhance a user's experience.

### BRIEF DESCRIPTION OF THE DRAWINGS

The foregoing brief description, as well as other objects, features and advantages of the present invention be understood more completely from the following detailed description of a presently preferred, but nonetheless illustrative, embodiment in accordance with the present invention, with reference being had to the accompanying drawings in which:

FIG. 1 is a flowchart illustrating the reading of the data stored in the Hookie;

FIG. 2, is a flowchart illustrating the process of updating such data;

FIG. 3 is a flowchart illustrating a second embodiment for cookie-less user identification making use of a stored file;

FIG. 4 is a flowchart illustrating a third embodiment for cookie-less user identification making use of a stored file;

FIG. 5 is a flowchart illustrating a fourth embodiment for cookie-less user identification making use of an identification code stored in hardware; and

FIG. 6 is a functional block diagram illustrating the environment of the present invention and some of the fundamental concepts involved.

### DETAILED DESCRIPTION OF THE PREFERRED EMBODIMENT

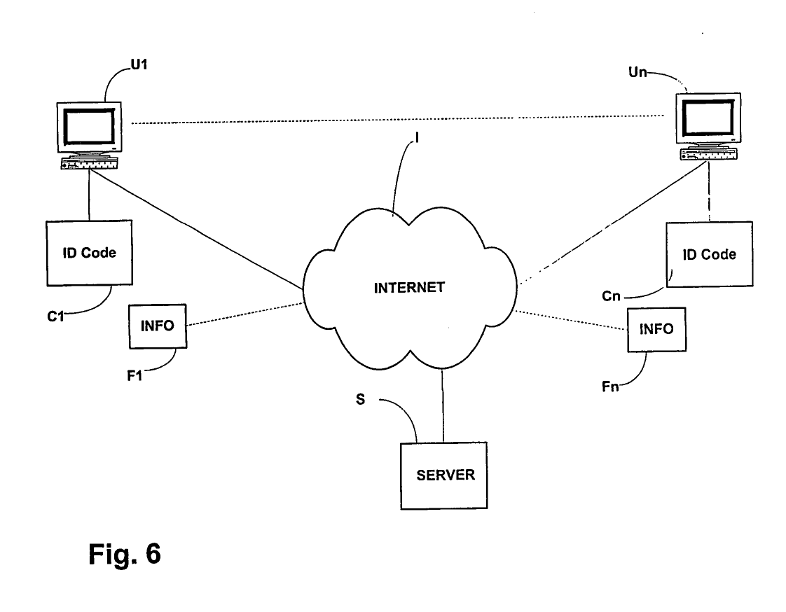

FIG. 6 is a functional block diagram illustrating the environment of the present invention and some of the fundamental concepts involved. A plurality of user or client computers U1 . . . UN are connected to a network, such as the internet I. Also connected to the internet is a server computer S. The server computer and client computers can therefore communicate through the internet. At least one ID code (see 1 . . . Cn) is provided on each client's computer. These code are uniquely associated with either the computer or one of the users on the computer. As will be explained further below, the code may be stored either in hardware on the computer or in the form of an electrical signal or file which is independent of any cookie. Stored on the network is information (F1 . . . Fn) about each user, and this information is stored in association with the respective ID code. As will become clear below, the information may either be stored on the client computer or on the server. In operation, when a client computer communicates with server S over the internet, the respective ID code is provided to the server. The server can then identify the user, can access the user information, and can update the user information for providing individual content or commercial messages to the user.

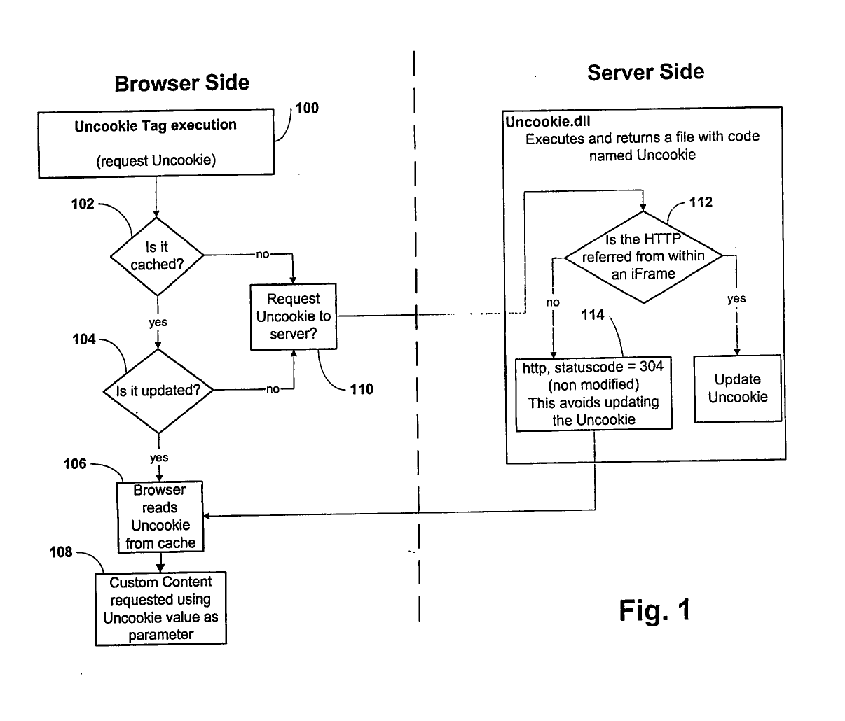

Referring to the flowchart of FIG. 1, reading of the Hookie starts in block 100 with the execution of a tag in an HTML file that requests the execution of a program called “Uncookie.dll.” This program produces an Hookie file which contains user-related information and is stored in the cache. However, during the read operation of FIG. 1, it is important that the cache information is not overwritten. As explained below in blocks 102 and 104, the browser determines whether the Hookie file resulting from the execution of Uncookie.dll is in the cache and whether the Hookie is up to date. These are the normal steps performed by a browser when a file is requested. If the Hookie is both cached and up to date, the browser reads the Hookie file from the cache (block 106), and uses the data stored in it for parameters for further operations (block 108). Such operations could be, for example, getting special content for the user.

If on the other hand, the Hookie file, is not present in the cache (“no” at block 102) or if the browser determines that it must retrieve an updated version (“no” at block 104), it automatically performs a request to the server with which it is communicating (block 1 10). The server receives the request and in block 11 2 verifies if it was made from within an iframe (a conventional frame used, for example, for banner ads). If the Hookie is within an iframe (“yes” at block 12), the Hookie is updated. However, in the present instance, the Hookie tag is located in the body of the HTML document and not in an iframe, so the result at block 112 is negative, resulting in an http status code equal to 304 (Block 114). This indicates that the file is current and does not need updating. This avoids delivering a new Hookie file to the browser, which would overwrite the old one. The browser then defaults to the Hookie file in the cache, and if none is stored, uses stored default value (block 106).

The preceding process prevents updating of the Hookie file when reading it. This amounts to providing special treatment for an Hookie, since the browser normally updates a cached file automatically when accessing it. As indicated above an Hookie update will be allowed only if requested from within an iframe.

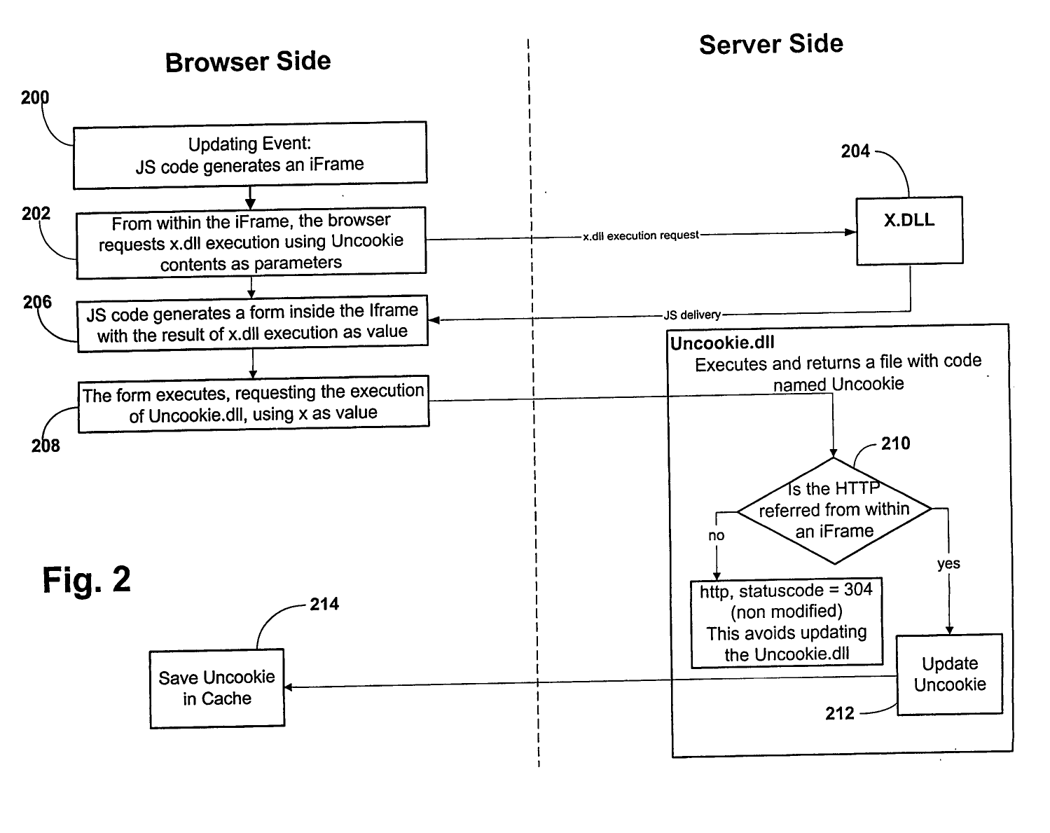

The flowchart of FIG. 2 illustrates the preferred Hookie writing process, which begins with the execution of an external updating event in block 200. As a result of this event, JavaScript code generates an iframe. In block 202, from within the Iframe, execution is requested of a program called x.dll, using as parameters user data stored in the Hookie. The server runs those parameters through the x.dll program in block 204 and returns the results to the browser. The x.dll program merely updates the users parameters based upon a pre-programmed sequence or information stored in a database.

At block 206, JavaScript code generates a form inside the iframe using the results of x.dll execution as values. In block 208 the form requests the execution of Uncookie.dll. The form is used in order to avoid having the browser automatically request the file from the cache, as in blocks 102, 104 and 110. Thus special treatment is again obtained for the Hookie. The server receives the request and executes Uncookie.dll, as shown in block 210. Since the form was executed inside the iframe, the test produces a positive result, and the Hookie data is updated in block 212. The updated Hookie file is then sent to the browser and stored in the cache (Block 214).

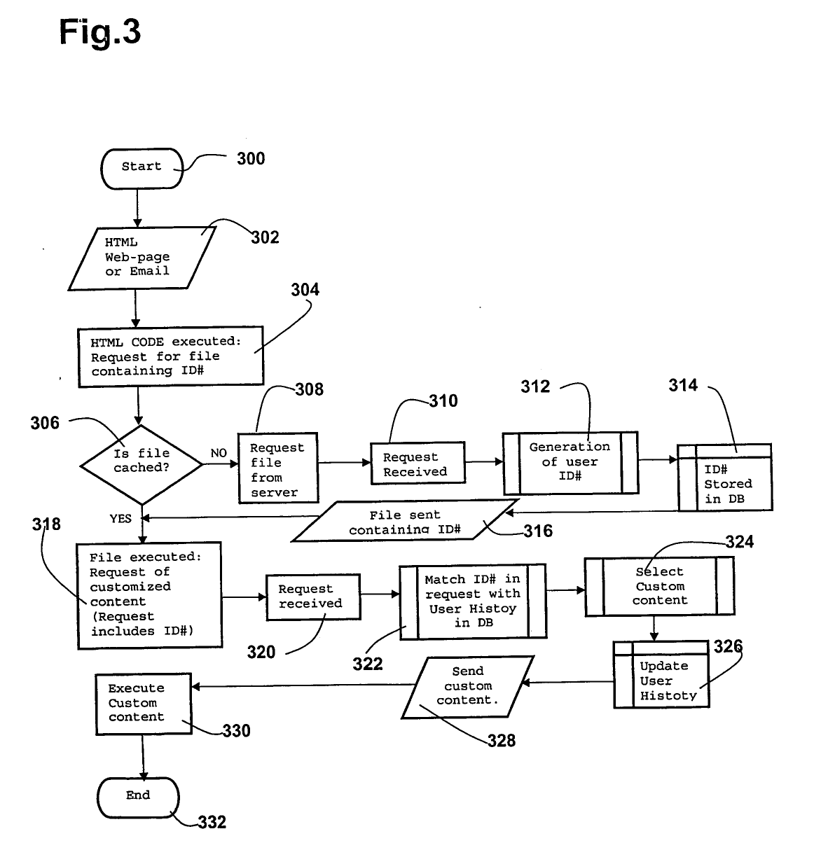

FIG. 3 is a flowchart illustrating an alternate cookie-less process for user identification. This embodiment utilizes the Hookie only to store an identification code, doing away with the need to update data on the client side by hosting all information on the server side. The process begins at block 300, and an HTML web page or HTML e-mail is received from a server at block 302. At block 304, the identification process begins when the HTML code is executed and requests a predefined file, possibly a DLL, file which contains the user identification number.

As with any file, the first place the Internet browser looks for the file is in the Internet cache, performing a test at block 106 to determine whether the sought file has been cached. If not, the file is requested from te server at block 308, and the request is received by the server at block 310. At block 312, the server then runs a routine which generates a unique user identification and places it inside a file of predetermined name, which. At block 314, the user identification is stored in a database on the server. Then, at block 316, the file containing the used identification is sent to the user, where it is placed in the Internet cache. Then control transfers to block 318.

If it had been determined at block 306 that the file containing the user identification is in the Internet cache, that file is executed at block 318 and requests custom content from the server. That request is received by the server at block 320, and it matches the user identification number with in the request with the user history in the database in block 322, then, at block 324, selects custom content for the user, based the database information. The user history in the database is then updated at block 326, and the custom data is sent to the user at block 328. After receiving the custom data, the user executes it at block 330, and the process ends at block 332.

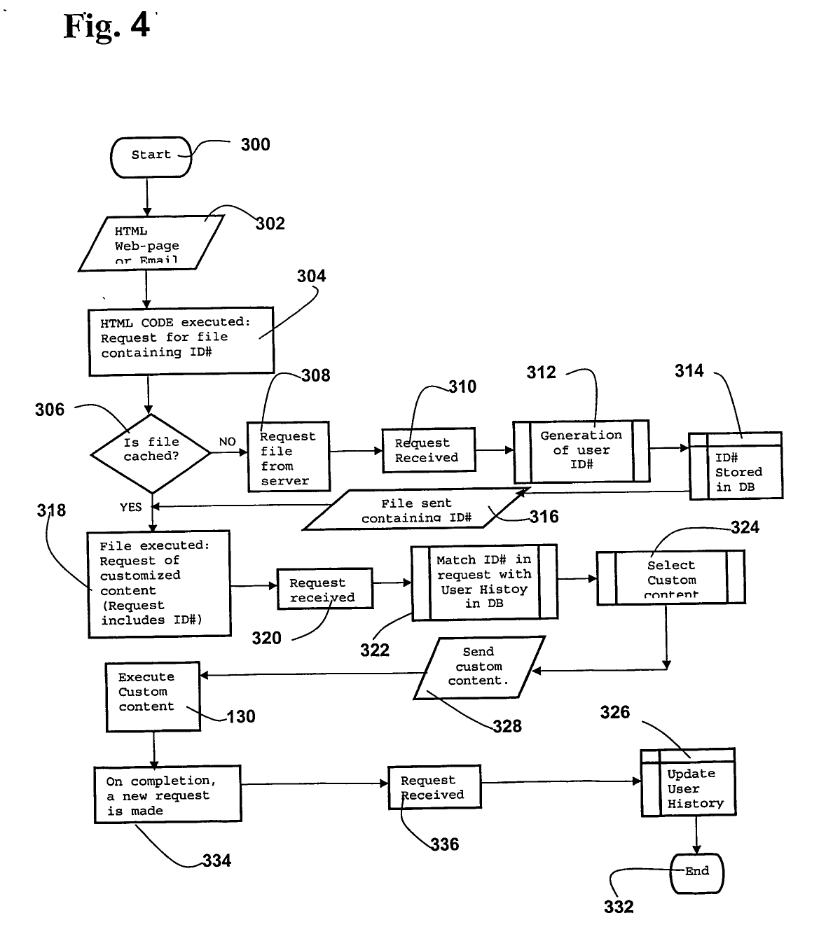

FIG. 4 is a flowchart illustrating another alternate embodiment of a cookie-less process for user identification which stores only an identification code in the Hookie. It will be appreciated that the method of claim to is identical to the method of FIG. 3 through block 324. Following block 324, the custom content is sent to the user at block 328, following which it is executed at block 330. Thereafter, the user makes a new request at block 334, which is received by the server at block 336. The server then updates the user history at block 326, and the process ends at block 332.

The method can be used to identify specific web surfers, so that customized content can be delivered to them when accessing a site or delivering an advertisement. It can also be used with HTML e-mails. As explained above the method can also be used to identify users across different servers

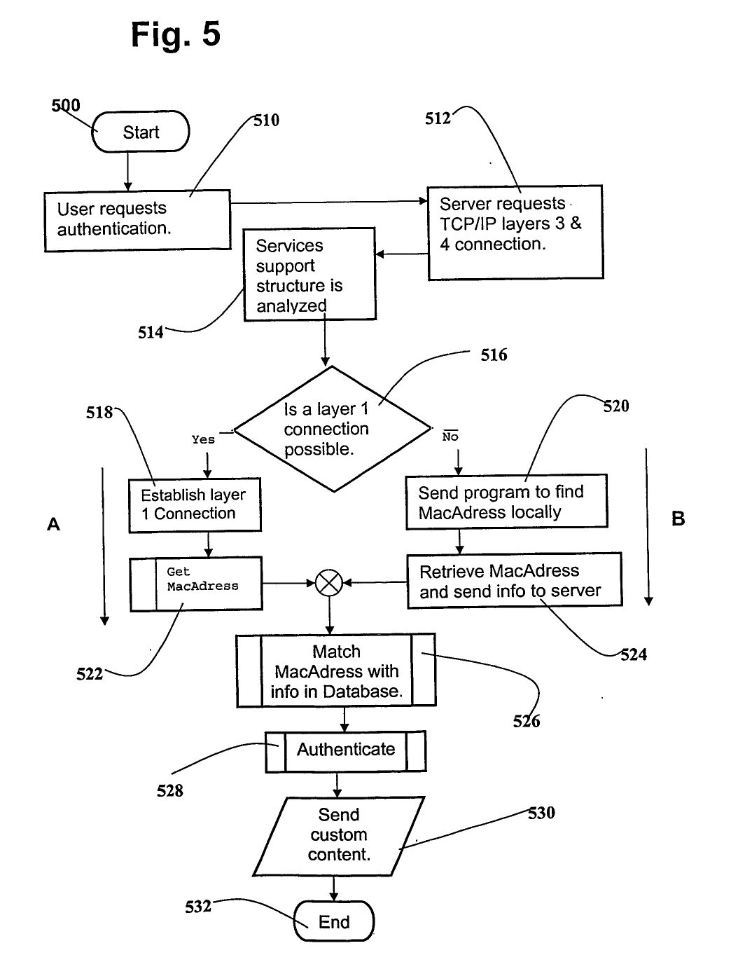

The fourth embodiment of the invention (FIG. 5) provides cookie-less identification of a user by making use of an identification code embedded in hardware.

The method currently described can be implemented across the Internet or on all types of networks. It can be used when serving HTML content, web or mail, or it can be built into all kinds of software. This method relies on a feature built into all networking devices called MacAdress. MacAdress refers to a unique identifier given to all active networking devices (modems, nic cards, etc. . . . ) present on a any network. This identifier is built into the hardware, cannot be modified, is unique and ever-present. It is utilized during the transaction of information packets between connected network appliances.

The MacAdress of all active devices inside a computer can always be accessed from such computer. Within a network, the MacAdress can be accessed if and only when no metric changes or masking takes place and the Netbios ports are left opened. The MacAdress can be accessed from a remote server across the web only in those cases when there is no metric change. If the user is accessing the web through a proxy or a gateway, the remote server cannot see the device's ID.

This limitation presents the following bifurcation in the preferred procedures:
1. A method for when the MacAdress can be accessed remotely.
2. A method for when the MacAdress cannot be accessed remotely.
   In the first case, described as a situation in which a “layer 1” or physical connection is possible, the identification of the user would be achieved directly and the flow of information would follow the path A described in flowchart of FIG. 5. In the second scenario, a program running locally at client computer would read the MacAdress and pass the data on to the remote server. This flow is charted in path B of the flowchart.

Turning now to FIG. 5, the process starts at block 500. At block 510, the user requests authentication, and the server requests a TCP/IP layer 3 and 4 connection at block 512. Layers 3 and 4 are the network and transport layers, respectively. At block 514, the service support structure is analyzed and, at block 516 determination is made whether or not the layer 1 connection is possible. If it is, operation proceeds to block 518 (path A) where a layer 1 connection is established. At block 522, the MacAddress from the user's computer is received, and control is transferred to block 526.

If it was determined at block 516 that a layer 1 connection is not possible, the server sends a program to the client which seeks a MacAddress locally at the client (block 520—path B). The server would typically do this in response to a file request by the client. The MacAddress at the client is retrieved (block 524) and sent to the information server (block 524). At which point, control is transferred to block 526.

At block 526, the MacAdress is matched with the information and the database, and it is then authenticated (block 528), at which point the user's identity has been established. At block 530, customized content is generated and sent to the user, and the process terminates at block 532.

More About Uses:

1. Customize content

2. Customize advertisements

3. Limiting site access to specific computers

By limiting access to information to registered devices, eventual snoops or hackers could not break into servers without physically entering the site containing authorized computers.

4. Enhancing transaction security

Tying all transactions to a specific machine, fraudulent transactions could be traced back to the originating hardware.

5. Copy-protecting software or limiting its installation to specific hardware

This would limit the functionality of a given piece of software to running it only on an authorized machine. Also, all documents created by such software could include an id linking them to the original machine in which they were created.

6. locate hardware Geographically

This can be achieved because of the way in which MacAdresses are assigned: regionally.

1. For use in a network including a server computer and a plurality of client computers connected for communication with the server through the network, a method for identifying one of the client computers or a user of the one computer, comprising the steps of:
maintaining on the one client computer an identification signal representing an identification code which is unique to the one client computer or one user of that computer, the identification signal being independent of any cookie;
storing on the network and in association with the identification signal client information signals representing information related to the client computer or the one user; and
providing the identification signal from the client computer to the server computer when the client computer communicates with the server computer over the network.

2. The method of claim 1, utilized in a system wherein the network is the Internet and the one client computer has an Internet cache, the identification signal being stored in an identification file in the Internet cache of the one client computer, identification file not being defined as a cookie in the one client computer.

3. The method of claim 2, wherein at least a portion of the information signals is stored in the identification file.

4. The method of claim 3, wherein the information in the identification file is matched to information stored on the server computer.

5. The method of claim 1, wherein at least a portion of the information signals is stored in the server computer.

6. The method of claim 1, wherein the identification signal being available in a hardware component in the one client computer.

7. The method of claim 6, wherein the identification signal being the Mac Address of a network card in the one client computer.

8. The method of claim 1, wherein a copy of the Mac Address of a computer which communicates with the server computer is stored on the server computer and is subsequently compared to the Mac Address received from a client computer to verify the identity thereof.

9. In a network including a server computer and a plurality of client computers connected for communication with the server through the network, an improvement for identifying one of the client computers or a user of the one computer, comprising:
an identification signal representing an identification code which is unique to the one client computer or one user of that computer stored on the one client computer, the identification signal being independent of any cookie;
client information signals representing information related to the client computer or the one user are stored on the network and in association with the identification signal; and
executable in the one client computer providing the identification signal from the client computer to the server computer when the client computer communicates with the server computer over the network.

10. The improvement of claim 9, utilized in a system wherein the network is the Internet and the one client computer has an Internet cache, the identification signal being stored in an identification file in the Internet cache of the one client computer, identification file not being defined as a cookie in the one client computer.

11. The improvement of claim 10, wherein at least a portion of the information signals is stored in the identification file.

12. The improvement of claim 11, further comprising a comparator matching the information in the identification file to information stored on the server computer.

13. The improvement of claim 9, wherein at least a portion of the information signals is stored in the server computer.

14. The improvement of claim 9, wherein the identification signal is stored in a hardware component in the one client computer.

15. The improvement of claim 14, wherein the identification signal being the Mac Address of a network card in the one client computer.

16. The improvement of claim 9, wherein a copy of the Mac Address of a computer which communicates with the server computer is stored on the server computer, and further comprising a comparator which compared to the stored Mac Address to the Mac Address received from a client computer to verify the identity thereof.

17. The method of claim 2, wherein a copy of the Mac Address of a computer which communicates with the server computer is stored on the server computer and is subsequently compared to the Mac Address received from a client computer to verify the identity thereof.

18. The method of claim 3, wherein a copy of the Mac Address of a computer which communicates with the server computer is stored on the server computer and is subsequently compared to the Mac Address received from a client computer to verify the identity thereof.

19. The method of claim 4, wherein a copy of the Mac Address of a computer which communicates with the server computer is stored on the server computer and is subsequently compared to the Mac Address received from a client computer to verify the identity thereof.

20. The method of claim 5, wherein a copy of the Mac Address of a computer which communicates with the server computer is stored on the server computer and is subsequently compared to the Mac Address received from a client computer to verify the identity thereof.

21. The method of claim 6, wherein a copy of the Mac Address of a computer which communicates with the server computer is stored on the server computer and is subsequently compared to the Mac Address received from a client computer to verify the identity thereof.

22. The method of claim 7, wherein a copy of the Mac Address of a computer which communicates with the server computer is stored on the server computer and is subsequently compared to the Mac Address received from a client computer to verify the identity thereof.

23. The improvement claim 10, wherein a copy of the Mac Address of a computer which communicates with the server computer is stored on the server computer, and further comprising a comparator which compared to the stored Mac Address to the Mac Address received from a client computer to verify the identity thereof.

24. The improvement claim 11, wherein a copy of the Mac Address of a computer which communicates with the server computer is stored on the server computer, and further comprising a comparator which compared to the stored Mac Address to the Mac Address received from a client computer to verify the identity thereof.

25. The improvement claim 12, wherein a copy of the Mac Address of a computer which communicates with the server computer is stored on the server computer, and further comprising a comparator which compared to the stored Mac Address to the Mac Address received from a client computer to verify the identity thereof.

26. The improvement claim 13, wherein a copy of the Mac Address of a computer which communicates with the server computer is stored on the server computer, and further comprising a comparator which compared to the stored Mac Address to the Mac Address received from a client computer to verify the identity thereof.

27. The improvement claim 14, wherein a copy of the Mac Address of a computer which communicates with the server computer is stored on the server computer, and further comprising a comparator which compared to the stored Mac Address to the Mac Address received from a client computer to verify the identity thereof.

28. The improvement claim 15, wherein a copy of the Mac Address of a computer which communicates with the server computer is stored on the server computer, and further comprising a comparator which compared to the stored Mac Address to the Mac Address received from a client computer to verify the identity thereof.
